(19) United States
(12) Patent Application Publication
(10) Pub. No.: US 2015/0061595 A1
(43) Pub. Date: Mar. 5, 2015

(54) BATTERY PROTECTION SYSTEM AND BATTERY PROTECTION METHOD USING THE SAME

(71) Applicant: SAMSUNG SDI CO., LTD., Yongin-si (KR)

(72) Inventors: Jin-Wan KIM, Yongin-si (KR); Masami OMAGARI, Yongin-si (KR)

(21) Appl. No.: 14/464,076

(22) Filed: Aug. 20, 2014

Related U.S. Application Data
(60) Provisional application No. 61/872,254, filed on Aug. 30, 2013.

(51) Int. Cl. H02J 7/00

(52) U.S. Cl. CPC H02J 7/0026; H02J 7/0021; H02J 2007/0037; H02J 2007/004; H02J 7/0042
USPC 320/112; 320/134; 320/107

(57) ABSTRACT

A battery protection system includes a first battery, a first line coupled to a first electrode of the first battery, and a second line coupled to a second electrode of the first battery, the first and second electrodes being of opposite polarity, a measurement unit measuring a voltage at first and second measurement terminals, the first measurement terminal being connected to the first electrode by the first line, the second measurement terminal being connected to the second electrode by the second line, and a protection unit controlling a voltage of the first battery according to a generated voltage, the generated voltage being determined by adjusting the measured voltage according to a first voltage drop across the first line, a second voltage drop across the second line, or both the first voltage drop and the second voltage drop.

### CROSS-REFERENCE TO RELATED APPLICATION

The present application claims priority under 35 U.S.C. §119 to U.S. Provisional Application No. 61/872,254, filed on Aug. 30, 2013, and entitled: “Battery Protection System and Battery Protection Method Using The Same,” which is incorporated herein by reference in its entirety.

### BACKGROUND

1. Field

Embodiments relate to a battery protection system and a battery protection method using the same.

2. Description of the Related Art

Recently, various portable devices have been developed and are widely used. Accordingly, batteries for supplying power to the portable devices have become increasingly important.

### SUMMARY

Embodiments are directed to a battery protection system, including a first battery, a first line coupled to a first electrode of the first battery, and a second line coupled to a second electrode of the first battery, the first and second electrodes being of opposite polarity, a measurement unit measuring a voltage at first and second measurement terminals, the first measurement terminal being connected to the first electrode by the first line, the second measurement terminal being connected to the second electrode by the second line, and a protection unit controlling a voltage of the first battery according to a generated voltage, the generated voltage being determined by adjusting the measured voltage according to a first voltage drop across the first line, a second voltage drop across the second line, or both the first voltage drop and the second voltage drop.

The protection unit may stop a charging operation of the first battery when the generated voltage exceeds a reference voltage.

The protection unit may stop a discharging operation of the first battery when the generated voltage is lower than a reference voltage.

The first electrode may be a positive electrode and the second electrode may be a negative electrode, the measured voltage may be a potential across the first and second measurement terminals when the first battery is being charged, and the generated voltage may be determined by adjusting the measured voltage by subtracting the first voltage drop and the second voltage drop from the measured voltage.

The first electrode may be a positive electrode and the second electrode may be a negative electrode, the measured voltage may be a potential across the first and second measurement terminals when the first battery is being discharged, and the generated voltage may be determined by adjusting the measured voltage by adding the first voltage drop and the second voltage drop to the measured voltage.

The battery protection system may further include a second battery in series with the first battery, a first electrode of the second battery being connected to the second electrode of the first battery, a third measurement terminal connected to a second electrode of the second battery by a third line, and a control unit that selects from among the first, second, and third measurement terminals, the measured voltage being measured at the selected measurement terminals.

Embodiments are also directed to a battery protection system, including a first line coupled to a first electrode of a battery, and a second line coupled to a second electrode of the battery, the first and second electrodes being of opposite polarity, a measurement unit measuring a voltage at first and second measurement terminals, the first measurement terminal being connected to the first electrode by the first line, the second measurement terminal being connected to the second electrode by the second line, and a protection unit, the protection unit controlling a voltage of the battery according to a generated voltage, the generated voltage being determined by adjusting the measured voltage potential according to a first voltage drop across the first line, a second voltage drop across the second line, or both the first voltage drop and the second voltage drop.

Embodiments are also directed to a method of controlling a battery voltage, including determining a first voltage across measurement terminals that are connected to first and second electrodes of a first battery, respectively, determining a second voltage by adding or subtracting a predetermined value to the first voltage, and interrupting a charge or discharge operation of the first battery when the second voltage is at a reference voltage.

The predetermined value may be subtracted from the first voltage, and the charge operation may be interrupted when the second voltage is at the reference voltage.

The predetermined value may be added to the first voltage, and the discharge operation may be interrupted when the second voltage is at the reference voltage.

A second battery may be connected to the first battery, a first measurement terminal being connected to a first electrode of the first battery, a second measurement terminal being connected to a second electrode of the first battery and a first electrode of the second battery, and a third measurement terminal being connected to a second electrode of the second battery, and the first and second batteries being connected in series between the first measurement terminal and the third measurement terminal, and the method may further include selecting two among the first, second, and third measurement terminals, and determining the first voltage across the selected measurement terminals.

Embodiments are also directed to a battery protection system, including a battery formed to include at least one battery pack in which first and second battery cells are connected in parallel, a first line for connecting positive electrodes of the battery cells, a second line for connecting negative electrodes of the battery cells, a third line for connecting a positive electrode of the battery pack with a protection module, a fourth line for connecting a negative electrode of the battery pack with the protection module, and the protection module for performing a protection operation which cuts off charging or discharging of the battery.

The protection module may determine a battery pack voltage value by subtracting a voltage drop from a measured voltage of the battery pack, and may control the charging and discharging of the battery by using the determined value.

### BRIEF DESCRIPTION OF THE DRAWINGS

Features will become apparent to those of skill in the art by describing in detail example embodiments with reference to the attached drawings in which:

FIG. 1 illustrates a structure of a battery protection system in accordance with an example embodiment.

FIG. 2 illustrates a flowchart showing a battery protection method in accordance with another example embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art.

In the drawing figures, the dimensions of layers and regions may be exaggerated for clarity of illustration. Like reference numerals refer to like elements throughout.

Throughout this specification, when a part is described as “comprising (or including)” constituent elements, this indicates that the part may further include other constituent elements unless particularly otherwise defined. In addition, the terms “-er”, “-or”, and “module” described in the specification refer to units for processing at least one function and operation, and can be implemented by hardware components or software components and combinations thereof.

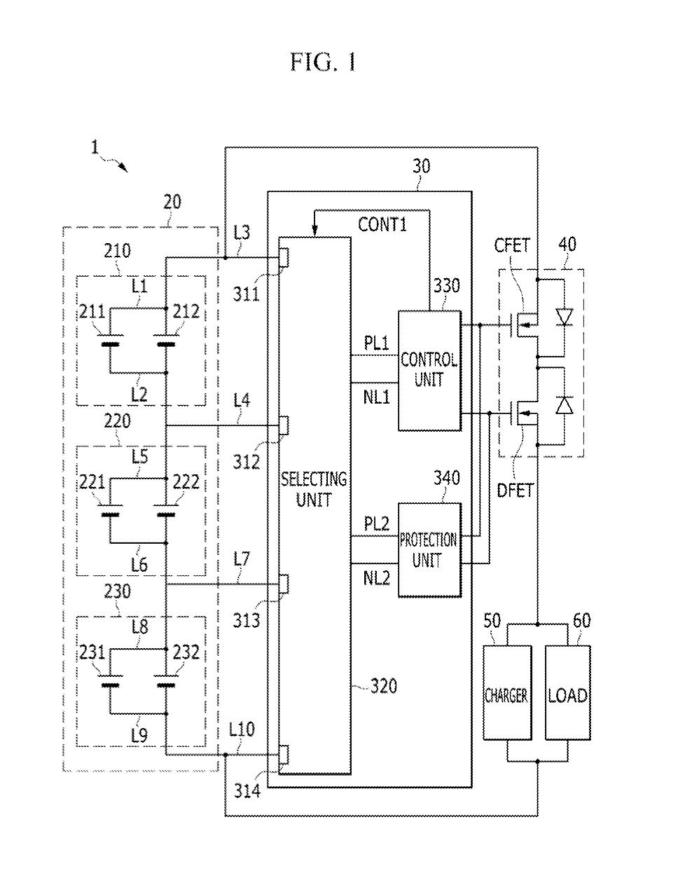

FIG. 1 illustrates a structure of a battery protection system 1 in accordance with an example embodiment.

Referring to FIG. 1, the battery protection system 1 of the present example embodiment may include a battery 20, a protection module 30, and a switch unit 40. The battery protection system 1 may measure a voltage of the battery 20 to perform a protection operation by using the measured voltage of the battery 20.

The protection operation indicates an operation that cuts off an electrical connection with external circuits of the battery 20 (external circuits may be, e.g., a charger 50, a load 60, etc.) when the measured voltage of the battery 20 exceeds a reference voltage.

In the example embodiment shown in FIG. 1, the charger 50 and the load 60 are respectively connected to opposite ends of the battery 20. The charger 50 serves to supply a charging voltage for charging the battery 20. The load 60 is operated using power supplied from the battery 20. One end of the charger 50 and one end of the load 60 are connected to a positive electrode of the battery 20. The other ends of the charger 50 and the load 60 are connected to a negative electrode of the battery 20.

The battery 20 may include a first battery pack 210 in which a plurality of battery cells 211 and 212 are connected (e.g., in parallel), a second battery pack 220 in which a plurality of battery cells 221 and 222 are connected (e.g., in parallel), and a third battery pack 230 in which a plurality of battery cells 231 and 232 are connected (e.g., in parallel).

Positive electrodes of the battery cells 211 and 212 are connected to a first line L1, and negative electrodes of the battery cells 211 and 212 are connected to a second line L2.

Positive electrodes of the battery cells 221 and 222 are connected to a fifth line L5, and negative electrodes of the battery cells 221 and 222 are connected to a sixth line L6.

Positive electrodes of the battery cells 231 and 232 are connected to an eighth line L8, and negative electrodes of the battery cells 231 and 232 are connected to a ninth line L9.

A third line L3 is connected to the first line L1, and a fourth line L4 is connected to the second line L2 and the fifth line L5. A seventh line L7 is connected to the sixth line L6 and the eighth line L8, and a tenth line L10 is connected to the ninth line L9.

The protection module 30 may include measurement terminals 311 to 314, a selecting unit 320, a control unit 330, and a protection unit 340.

The measurement terminal 311 of the protection module 30 is connected to the third line L3, and the measurement terminal 312 of the protection module 30 is connected to the fourth line L4. The measurement terminal 313 of the protection module 30 is connected to the seventh line L7, and the measurement terminal 314 of the protection module 30 is connected to the tenth line L10.

The selecting unit 320 may select a plurality of measurement terminals to correspond to selected battery packs or battery cells according to a selection control signal CONT1 of the control unit 330. The selecting unit 320 may receive voltages of the battery pack or battery cell selected through the selected measurement terminals.

For example, the selecting unit 320 may select the measurement terminal 311 and the measurement terminal 312 to correspond to the first battery pack 210 according to a selection control signal CONT1 that selects the first battery pack 210.

The selecting unit 320 may receive a positive electrode potential of the first battery pack 210 through the terminal 311. The selecting unit 320 may transmit the positive electrode potential of the first battery pack 210 to the control unit 330 through a positive electrode line PL1 and to the protection unit 340 through a positive electrode line PL2.

The selecting unit 320 may receive a negative electrode potential of the first battery pack 210 through the terminal 312. The selecting unit 320 may transmit the negative electrode potential of the first battery pack 210 to the control unit 330 through a negative electrode line NL1 and to the protection unit 340 through a negative electrode line NL2.

The protection unit 340 may select at least one battery pack and measure a voltage of the selected battery pack. When the measured voltage exceeds a predetermined reference voltage, the protection unit 340 may perform the protection operation, e.g., by controlling a switching operation of a charging switch CFET and a discharging DFET of the switch unit 40.

For example, the protection unit 340 may measure a voltage of the selected first battery pack 210 and perform the protection operation when the measured voltage of the first battery pack 210 exceeds the reference voltage.

In an implementation, the protection unit 340 may include a reference voltage adjusting unit (not shown) to adjust the reference voltage.

The control unit 330 may select at least one of the battery packs or battery cells of the battery 20 and generate the selection control signal CONT1 to correspond to the selected one, to transmit the selection control signal CONT1 to the selecting unit 320.

The control unit 330 may generate or determine an actual cell voltage value of the battery cells 211, 212, 221, 222, 231, and 332, and/or an actual battery pack voltage value of the battery packs 210, 220, and 230, by allowing for a plurality of voltage drop (first voltage drop to tenth voltage drop) components caused by resistance components of the lines L1, L2, L5, L6, L8, L9 (connecting the battery cells 211, 212, 221, 222, 231, and 332) and the lines L3, L4, L7, and L10 (connecting the battery 20 with the protection module 30). Each of the voltage drop components may be calculated in advance or may be experimentally measured.

The control unit 330 may control charging and discharging operations of the battery 20 using the determined battery cell voltage value and/or battery pack voltage value. For example, the control unit 330 may control the charging switch CFET to control the charging operation when the generated battery cell voltage value or battery pack voltage value is equal to or lower than the reference voltage, and control the discharging switch DFET to control the discharging operation when the determined battery cell voltage value or battery pack voltage value exceeds the reference voltage.

In general, when a battery is being charged, the measured voltage is higher than an actual cell voltage or battery pack voltage. Thus, a protection operation may be performed erroneously if it appears that the measured battery pack voltage exceeds the reference voltage. However, when the measured cell or battery cell voltage (as compared to the actual voltage) exceeds the reference voltage, the protection operation is not necessary unless the actual cell or battery cell voltage exceeds the reference voltage. Thus, according to the present example embodiment, the control unit 330 controls the switching operation of the charging switch CFET to disconnect the battery 20 from the charger 50 based on the determined voltage (which allows for a plurality of voltage drop components caused by resistance components of the lines L1, L2, L5, L6, L8, L9 and the lines L3, L4, L7, and L10). Thus, the control unit 330 may avoid an erroneous protection operation of the protection unit 340, which might otherwise be caused by a voltage drop.

For example, the control unit 330 may select the first battery pack 210 and measure the voltage of the first battery pack 210. The control unit 340 may determine the positive electrode potential of the first battery pack 210 by subtracting the third voltage drop caused by the third line L3 from the measured positive electrode potential. The control unit 330 may determine the negative electrode potential of the first battery pack 210 by adding the fourth voltage drop caused by the fourth line L4 to the measured negative electrode potential of the first battery pack 210. The control unit 330 may determine a voltage value of the first battery pack 210 as the difference between the determined positive electrode and the determined negative electrode potential of the first battery pack 212.

If the battery 20 is being charged, the protection unit 340 measures the positive electrode potential as a value obtained by adding the third voltage drop to the actual positive electrode potential of the first battery pack 210 and the negative electrode potential as a value obtained by adding the fourth voltage drop to the actual negative electrode potential of the first battery pack. Accordingly, the protection unit 340 may perform the protection operation when determining that a measured voltage of the first battery pack 210 added with the first voltage drop and the fourth voltage drop exceeds the reference voltage. When the determined voltage value of the first battery pack 210 (which accounts for the voltage drop components) is equal to or lower than the reference value, the protection operation is not necessary. Accordingly, the control unit 330 may avoid an erroneous protection operation of the protection unit 340, in which charging of the battery 20 is cut off prematurely.

In an implementation, the control unit 330 may select the first battery cell 211 and measure the positive electrode potential and the negative electrode potential of the first battery cell 211. The control unit 330 may determine the positive electrode potential of the first battery cell 211 as a value obtained by subtracting the first voltage drop caused by the first line L1 and the third voltage drop caused by the third line L3 from the measured positive electrode potential of the first battery cell 211. The control unit 330 may determine the negative electrode potential of the first battery cell 211 as a value obtained by adding the second voltage drop caused by the second line L2 and the fourth voltage drop caused by the fourth line L4 to the measured negative electrode potential of the first battery cell 211. The control unit 330 may determine a voltage value of the first battery cell 211 as the difference between the determined positive electrode potential and the determined negative electrode potential of the first battery cell 211.

In an implementation, the control unit 330 may include a reference voltage adjusting unit (not shown) to adjust the reference voltage.

In the example embodiment shown in FIG. 1, the switch unit 40 includes the charging switch CFET and the discharging switch DFET. The charging switch CFET and the discharging switch DFET are electrically connected to the control unit 330 and the protection unit 340, and are controlled by the control unit 330 and the protection unit 340.

As described above, the battery protection system 1 may have a measurement unit to perform voltage measuring. The battery protection system 1 may perform measurement using the control unit 330, e.g., whereby the control unit 330 selects the first battery pack 210 and measures the voltage of the first battery pack 210, or may perform measurement using the protection unit 340, e.g., whereby the protection unit 340 measures a voltage of the selected first battery pack 210).

FIG. 1 illustrates one battery pack including two battery cells connected in parallel for better understanding and ease of description, but other numbers, e.g., three or more, of the battery cells connected in parallel may be included in one battery pack.

Also, FIG. 1 illustrates the battery cells connected by using the first to tenth lines for better understanding and ease of description, but, when three or more battery cells connected in parallel are included in one battery pack, the battery packs may be connected by using a corresponding number of lines.

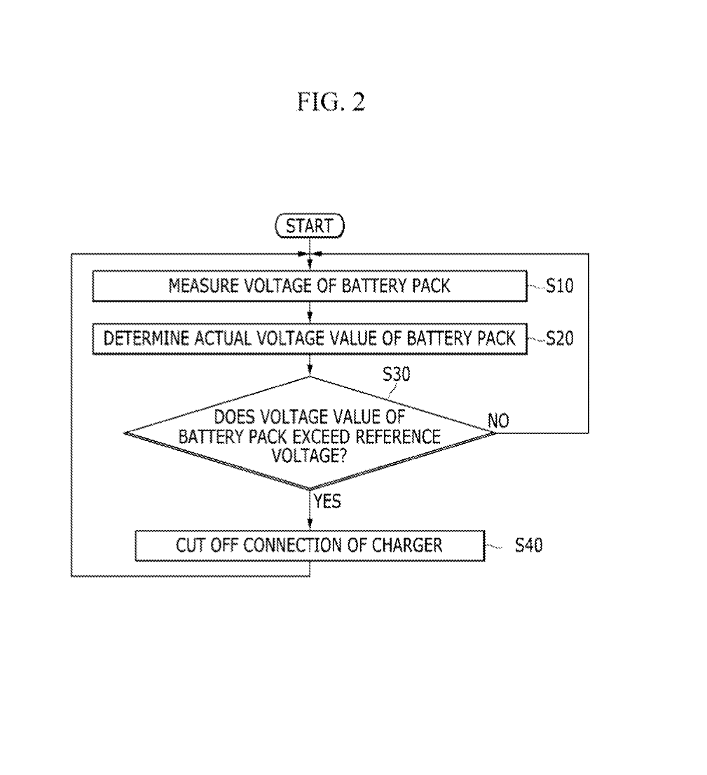

FIG. 2 illustrates a flowchart showing a battery protection method during charging in accordance with another example embodiment.

Herein, the detailed structures and corresponding operations of the control unit 330 are the same as described above, and thus redundant descriptions thereof may be omitted.

Referring to FIG. 2, the control unit 330 selects at least one battery pack and measures a positive electrode potential and a negative electrode potential of the selected battery pack (operation S10).

The control unit 330 determines an actual battery pack voltage value by subtracting voltage drops caused by lines connected to the selected battery pack and battery cell from the measured positive and negative electrode potentials of the battery pack (operation S20).

The control unit 330 evaluates whether or not the determined battery pack voltage value (which reflects the voltage drops) exceeds a reference voltage, and does not disconnect the battery 20 from the charger 50 if the determined battery pack voltage value is equal to or lower than the reference voltage (operation S30). If the determined battery pack voltage value exceeds the reference voltage, the control unit 330 disconnects the battery 20 from the charger 50 so as to stop charging the battery 20 (operation S40).

The operations may repeat as another one battery pack or more are selected and voltages of the selected battery packs are measured.

By way of summation and review, efforts are under way to improve battery functions, e.g., not only to increase battery capacity to expand available use time of portable devices, but also to enhance safety in using batteries and precisely measuring battery residual capacity. A battery for a portable device may be manufactured so as to include a plurality of battery cells, various sensors for measuring battery residual capacity and the like, and a protection circuit. However, without consideration of a voltage drop, a malfunction in a protection operation may occur.

As described above, embodiments relate to improving accuracy in battery protection by allowing for a voltage drop with respect to a high battery cell voltage (potential) during charging and a voltage drop of a low battery cell voltage during discharging. Embodiments may provide a battery protection system and a battery protection method using the same, having advantages of improving accuracy in voltage measurement of battery cells by allowing for a voltage drop of a parallel structure of the battery cells. Further, embodiments may provide a battery protection system and a battery protection method using the same, having advantages of preventing malfunctions in a battery-cell protection unit.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

<Description of Symbols>

| | |
|---|---|
| 1: battery protection system | 20: battery |
| 30: protection module | 40: switch unit |
| 50: charger | 60: load |
| 210: first battery pack | 211: first battery cell |
| 212: second battery cell | 220: second battery pack |
| 221: third battery cell | 222: fourth battery cell |
| 230: third battery pack | 231: fifth battery cell |
| 232: sixth battery cell | 311 to 314: measurement terminal |
| 320: selecting unit | 330: control unit |
| 340: protection unit | |

What is claimed is:

1. A battery protection system, comprising:
a first battery;
a first line coupled to a first electrode of the first battery, and a second line coupled to a second electrode of the first battery, the first and second electrodes being of opposite polarity;
a measurement unit measuring a voltage at first and second measurement terminals, the first measurement terminal being connected to the first electrode by the first line, the second measurement terminal being connected to the second electrode by the second line; and
a protection unit controlling a voltage of the first battery according to a generated voltage, the generated voltage being determined by adjusting the measured voltage according to a first voltage drop across the first line, a second voltage drop across the second line, or both the first voltage drop and the second voltage drop.

2. The battery protection system as claimed in claim 1, wherein the protection unit stops a charging operation of the first battery when the generated voltage exceeds a reference voltage.

3. The battery protection system as claimed in claim 1, wherein the protection unit stops a discharging operation of the first battery when the generated voltage is lower than a reference voltage.

4. The battery protection system as claimed in claim 1, wherein:
the first electrode is a positive electrode and the second electrode is a negative electrode,
the measured voltage is a potential across the first and second measurement terminals when the first battery is being charged, and
the generated voltage is determined by adjusting the measured voltage by subtracting the first voltage drop and the second voltage drop from the measured voltage.

5. The battery protection system as claimed in claim 1, wherein:
the first electrode is a positive electrode and the second electrode is a negative electrode,
the measured voltage is a potential across the first and second measurement terminals when the first battery is being discharged, and
the generated voltage is determined by adjusting the measured voltage by adding the first voltage drop and the second voltage drop to the measured voltage.

6. The battery protection system as claimed in claim 1, further comprising:
a second battery in series with the first battery, a first electrode of the second battery being connected to the second electrode of the first battery;
a third measurement terminal connected to a second electrode of the second battery by a third line; and
a control unit that selects from among the first, second, and third measurement terminals, the measured voltage being measured at the selected measurement terminals.

7. A battery protection system, comprising:
a first line coupled to a first electrode of a battery, and a second line coupled to a second electrode of the battery, the first and second electrodes being of opposite polarity;
a measurement unit measuring a voltage at first and second measurement terminals, the first measurement terminal being connected to the first electrode by the first line, the second measurement terminal being connected to the second electrode by the second line; and
a protection unit, the protection unit controlling a voltage of the battery according to a generated voltage, the generated voltage being determined by adjusting the measured voltage potential according to a first voltage drop across the first line, a second voltage drop across the second line, or both the first voltage drop and the second voltage drop.

8. A method of controlling a battery voltage, comprising:
determining a first voltage across measurement terminals that are connected to first and second electrodes of a first battery, respectively;
determining a second voltage by adding or subtracting a predetermined value to the first voltage; and
interrupting a charge or discharge operation of the first battery when the second voltage is at a reference voltage.

9. The method as claimed in claim 8, wherein the predetermined value is subtracted from the first voltage, and the charge operation is interrupted when the second voltage is at the reference voltage.

10. The method as claimed in claim 8, wherein the predetermined value is added to the first voltage, and the discharge operation is interrupted when the second voltage is at the reference voltage.

11. The method as claimed in claim 8, wherein a second battery is connected to the first battery, a first measurement terminal being connected to a first electrode of the first battery, a second measurement terminal being connected to a second electrode of the first battery and a first electrode of the second battery, and a third measurement terminal being connected to a second electrode of the second battery, and the first and second batteries being connected in series between the first measurement terminal and the third measurement terminal, the method further comprising:
selecting two among the first, second, and third measurement terminals, and determining the first voltage across the selected measurement terminals.
